(19) United States
(12) Patent Application Publication
(10) Pub. No.: US 2007/0229479 A1
(43) Pub. Date: Oct. 4, 2007

(54) Panel assembly

(75) Inventors: Dae-Ho Choo, Seongnam-si (KR); Ho-Min Kang, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/638,291

(22) Filed: Dec. 12, 2006

(30) Foreign Application Priority Data
Mar. 28, 2006 (KR) 10-2006-0027884

(51) Int. Cl. G06F 3/043

(52) U.S. Cl. 345/177

(57) ABSTRACT

A panel assembly is provided. The panel assembly includes a first panel having a first insulating substrate, and a second panel having a second insulating substrate and a touch sensing portion formed on the second insulating substrate. The first panel and the second panel face each other.

### CROSS-REFERENCE RELATED APPLICATION

This Application claims priority from a Korean patent application number 10-2006-0027884 filed on Mar. 28, 2006, and all the benefits accruing therefrom under 35 U.S.C. §119, the contents of which are incorporated by reference herein in its entirety.

### BACKGROUND OF THE INVENTION

(a) Field of the Invention

The present invention relates to a panel assembly, and more particularly, to a panel assembly having an input function.

(b) Description of the Related Art

As semiconductor techniques are rapidly developed, demands for light, compact display apparatuses, such as an improved liquid crystal display (LCD), increase greatly.

An LCD apparatus has many advantages including light weight, small size, and low power consumption. Therefore, the LCD apparatus has been highlighted as a suitable means for overcoming the shortcomings of a conventional cathode ray tube (CRT) display apparatus. Recently, LCD apparatuses have been widely used in nearly all information processing devices, including small-sized products, such as mobile phones or portable digital assistants (PDAs), as well as large/medium-sized products such as monitors and television sets.

Conventionally, a touch panel has been separately attached to the panel assembly for displaying images in the display apparatus for a user's convenience. Such a touch panel allows the panel assembly to have an input function, in addition to display and output functions, so that users can more conveniently obtain required information.

However, a conventional touch panel has been typically fabricated in a separate unit and then attached to a front surface of the panel assembly. This makes a manufacturing process more complicated and reduces productivity.

In addition, a conventional touch panel frequently generates degradation of image quality in the entire panel assembly due to deterioration of the touch panel. That is, the touch panel attached to the panel assembly degrades optical properties of the panel assembly and decreases resolution. Furthermore, a conventional touch panel has been a limitation to a display area of the panel assembly. That is, when the touch panel is attached to the panel assembly, the area of the panel assembly cannot be formed as a large area.

### SUMMARY OF THE INVENTION

The present invention provides a panel assembly for maximizing a display area and minimizing degradation of an image quality while providing an input function.

According to an aspect of the present invention, there is provided a panel assembly including: a first panel having a first insulating substrate; a second panel having a second insulating substrate, the second panel facing the first panel; and a touch sensing portion formed on the second insulating substrate.

The touch sensing portion may include an ultrasonic waveguide layer formed on the second insulating substrate; ultrasonic transmitting and receiving portions formed on the ultrasonic waveguide layer; and a passivation layer formed on the ultrasonic waveguide layer.

The touch sensing portion may be formed on the second insulating substrate facing the first panel.

The first panel may include a thin-film transistor, a pixel electrode, and a color filter formed on the first insulating substrate, and the second panel may further include a common electrode formed on the second insulating substrate.

The touch sensing portion may further include a transparent electrode layer interposed between the second insulating substrate and the ultrasonic waveguide layer.

The touch sensing portion may further include a transparent electrode layer surrounded by the ultrasonic waveguide layer, the ultrasonic transmitting and receiving portions, and the passivation layer.

The touch sensing portion may further include a first transparent electrode layer interposed between the second insulating substrate and the ultrasonic waveguide layer, and a second transparent layer surrounded by the ultrasonic waveguide layer, the ultrasonic transmitting and receiving portions, and the passivation layer.

The first panel may include a thin-film transistor formed on the first insulating substrate and a pixel electrode, and the second panel may further include a color filter formed on the second insulating substrate and a common electrode.

The color filter may be interposed between the second insulating substrate and the touch sensing portion.

The touch sensing portion may further include a transparent electrode layer interposed between the second insulating substrate and the ultrasonic waveguide layer.

The touch sensing portion may further include a transparent electrode layer surrounded by the ultrasonic waveguide layer, the ultrasonic transmitting and receiving portions, and the passivation layer.

The touch sensing portion may further include a first transparent electrode layer interposed between the second insulating substrate and the ultrasonic waveguide layer, and a second transparent electrode layer surrounded by the ultrasonic waveguide layer, the ultrasonic transmitting and receiving portions, and the passivation layer.

The touch sensing portion may be interposed between the second insulating substrate and the color filter.

The touch sensing portion may further include a transparent electrode layer interposed between the second insulating substrate and the ultrasonic waveguide layer.

The touch sensing portion may further include a transparent layer surrounded by the ultrasonic waveguide layer, the ultrasonic transmitting and receiving portions, and the passivation layer.

The touch sensing portion may further include a first transparent electrode layer interposed between the second insulating substrate and the ultrasonic waveguide layer, and a second transparent electrode layer surrounded by the ultrasonic waveguide layer, the ultrasonic transmitting and receiving portions, and the passivation layer.

The ultrasonic transmitting portion may include an X-axis transmitting portion formed at an edge of the ultrasonic waveguide layer and a Y-axis transmitting portion formed at a neighboring edge to the X-axis transmitting portion, and the ultrasonic receiving portion may include an X-axis receiving portion formed at an opposite edge to the X-axis transmitting portion and a Y-axis receiving portion formed at an opposite edge to the a Y-axis transmitting portion.

The ultrasonic transmitting portion may include a plurality of transmitting areas, lengths of the plurality of transmitting areas and distances between the neighboring transmitting areas being irregular, and the ultrasonic transmitting portion may transmit ultrasonic waves of various frequencies received from the plurality of transmitting areas.

The touch sensing portion may be formed beneath the second insulating substrate facing the first panel.

The ultrasonic transmitting portion may include a plurality of transmitting areas, and the ultrasonic transmitting portion may receive various driving signals and transmit ultrasonic waves of various frequencies received from the plurality of transmitting areas.

The touch sensing portion may be formed beneath the second insulating substrate facing the first panel.

Accordingly, the panel assembly may have an input function for receiving signals from outside as well as a display function for displaying images.

### BRIEF DESCRIPTION OF THE DRAWINGS

The above and other features and advantages of the present invention will become more apparent by describing in detail exemplary embodiments thereof with reference to the attached drawings, in which:

FIG. 1 is a cross-sectional view illustrating a panel assembly according to an embodiment of the present invention;

FIG. 2 is a schematic diagram illustrating a touch sensing portion of FIG.

FIG. 3 is an enlarged cross-sectional view illustrating the panel assembly of FIG. 1;

FIG. 4 is a schematic diagram illustrating a touch sensing portion according to a variation of the first embodiment of the present invention;

FIG. 5 is a cross-sectional view illustrating a panel assembly according to a second embodiment of the present invention;

FIG. 6 is an enlarged cross-sectional view illustrating the panel assembly of FIG. 5;

FIG. 7 is a cross-sectional view illustrating a panel assembly according to a third embodiment of the present invention;

FIG. 8 is an enlarged cross-sectional view illustrating the panel assembly of FIG. 7; and

FIG. 9 is a cross-sectional view illustrating a panel assembly according to a fourth embodiment of the present invention.

### DETAILED DESCRIPTION OF THE EMBODIMENTS

Hereinafter, exemplary embodiments of the present invention will be described in detail with reference to the attached drawings. The embodiments of the present invention are only exemplary, and the present invention is not limited thereto.

For clear description of the present invention, illustrations of unnecessary parts and their descriptions will be omitted, and like reference numerals refer to like elements throughout the entire specification.

In addition, all necessary components of the present invention will be representatively described in the first embodiment, and only components differing from the first embodiment will be described for the remaining embodiments. In the drawings, the thicknesses will be magnified for the purpose of clearly illustrating various layers and portions. In addition, like elements are denoted by like reference numerals throughout the whole specification. If it is mentioned that a layer, a film, an area, or a panel is placed on a different element, it includes a case that the layer, film, area, or panel is placed directly on the different element, as well as a case that another element is disposed therebetween. On the contrary, if it is mentioned that one element is placed directly on another element, it means that no element is disposed therebetween.

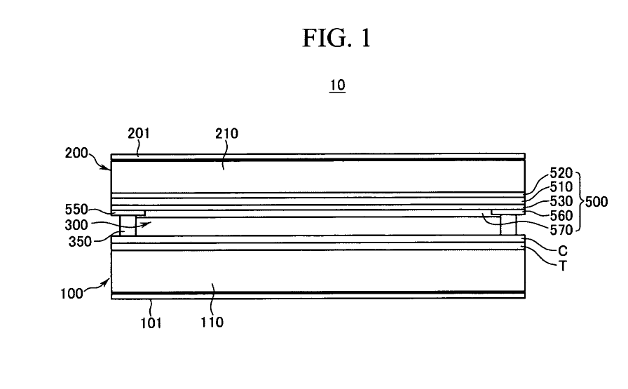

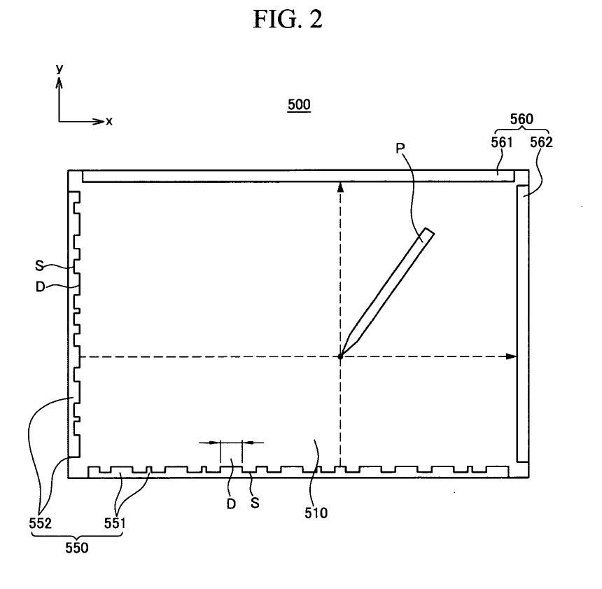

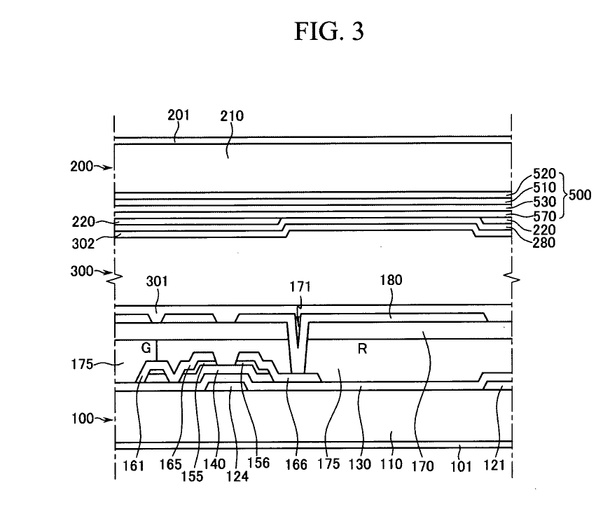

The first embodiment of the present invention will now be described with reference to FIGS. 1 to 3. FIG. 1 is a cross-sectional view illustrating a panel assembly 10, FIG. 2 is a schematic diagram illustrating the touch sensing portion 500 of FIG. 1, and FIG. 3 is an enlarged cross-sectional view illustrating the panel assembly 10 for a more detailed description.

As shown in FIG. 1, the panel assembly 10 includes a first panel 100 and a second panel 200 facing the first panel 100. It should be noted that the first panel serves as a back panel, and the second panel 200 serves as a front panel. In addition, a first polarization plate 101 is attached to the back side of the first panel 100, and a second polarization plate 201 is attached to the front side of the second panel 200. The first and second polarization plates 101 and 201 may be attached using an adhesive. The first and second polarization plates 101 and 201 are cross-polarized. The first polarization plate 101 polarizes the light incident to the panel assembly 10 and the second polarization plate 201 functions as an analyzer.

The first panel 100 includes a first insulating substrate 110, and a thin-film transistor forming layer T and a color filter forming layer C formed on the first insulating substrate 110. The second panel 200 includes a second insulating substrate 210, a touch sensing portion 500 formed on the second insulating substrate 210, and a common electrode 280 (shown in FIG. 3). It should be noted that the touch sensing portion 500 is formed on the second insulating substrate 210 facing the first panel 100. The first and second panels 100 and 200 are attached to face each other using a sealant 350, and a liquid crystal layer 300 is interposed between the first and second panels 100 and 200. The thin-film transistor forming layer T includes various wire line layers for forming a thin-film transistor, an insulating substrate, a semiconductor layer, and the like. In addition, the first panel 100 may further include a pixel electrode 180 (shown in FIG. 3) connected to the thin-film transistor. The color filter forming layer C may further include color filters 175 and a passivation layer 170.

As described above, since the second panel 200 includes the touch sensing portion 500, the second panel 200 functions as a touch panel as well as a display panel. In other words, signal information may be input by touching the second panel 200 with a user's finger or a pen P.

The touch sensing portion 500 includes an ultrasonic waveguide layer 510 formed on the second insulating substrate 210, ultrasonic transmitting and receiving portions 550 and 560 formed on the ultrasonic waveguide layer 510, and a passivation layer 570 formed on the ultrasonic waveguide layer 510 to cover the underlying layers. In addition, the touch sensing portion 500 further includes a first transparent electrode layer 520 interposed between the second insulating substrate 210 and the ultrasonic waveguide layer 510, and a second transparent electrode layer 530 surrounded by the ultrasonic waveguide layer 510, the ultrasonic receiving and transmitting portions 550 and 560, and the passivation layer 570.

The ultrasonic waveguide layer 510 is made of a material selected from a group consisting of zinc oxide (ZnO), AZO (i.e., Al-doped ZnO), and polyvinylidenefluoride (PVDF). The ultrasonic waveguide layer 510 formed of such a material delivers the ultrasonic waves transmitted from the ultrasonic transmitting portion 550 to the ultrasonic receiving portion 560 to allow a touch position to be sensed.

The first and second transparent electrode layers 520 and 530 are made of a transparent electrode material such as indium tin oxide (ITO) or indium zinc oxide (IZO).

In addition, a material used for the ultrasonic waveguide layer 510 is typically short of adhesion to other materials. Therefore, the ultrasonic waveguide layer 510 is vulnerable to a defect because it may come off, or become partially separated, from adjoining layers such as the second insulating substrate 210 and the passivation layer 570. For this reason, the ultrasonic waveguide layer 510 is interposed between the first and second transparent electrode layers 520 and 530 in order to prevent such an adhesive defect in the ultrasonic waveguide layer 510 as well as to guarantee an ultrasonic wave-guiding property of the ultrasonic waveguide layer 510. In other words, since the materials of the first and second transparent electrode layers 520 and 530, such as ITO and IZO, provide excellent adhesion, they allow the ultrasonic waveguide layer 510 to be safely stacked and attached.

However, the present invention is not limited to this construction, and at least one of the first and second transparent electrode layers 520 and 530 may be omitted. That is, only the transparent electrode layer 520 may be formed beneath the ultrasonic waveguide layer 510 or on the ultrasonic waveguide layer 510. In addition, both transparent electrode layers 520 and 530 may be omitted. The passivation layer 570 is formed on the second transparent electrode layer 530 to protect various underlying layers 510, 530, 530, 550, and 560. The passivation layer 570 is made of a polymer-based transparent or insulating material.

The ultrasonic transmitting and receiving portions 550 and 560 are made of a conductive material, such as copper or aluminum, using manufacturing methods including a vacuum evaporation process, a photolithographic process, or a printing process.

As shown in FIG. 2, the ultrasonic transmitting portion 550 includes an X-axis transmitting portion 551 formed at an edge of the ultrasonic waveguide layer 510 and a Y-axis transmitting portion 552 formed at the neighboring edge to the X-axis transmitting portion 551.

The ultrasonic receiving portion 560 includes an X-axis receiving portion 561 formed at the opposite edge to the X-axis transmitting portion 551 and a Y-axis receiving portion 562 formed at the opposite edge to the Y-axis transmitting portion 552.

The principle of sensing a touch by the touch sensing portion 500 will now be described. When an electric field is applied to the ultrasonic transmitting portion 550, an ultrasonic wave is generated from the ultrasonic transmitting portion 550 due to an electric field induction effect. It should be noted that the ultrasonic transmitting portion 550 may include a plurality of transmitting areas S that generate ultrasonic waves respectively.

As described above, each of the resonant ultrasonic waves generated from the ultrasonic transmitting portion 550 propagates through the ultrasonic waveguide layer 510. In this state, when a user touches the second panel 200 with a finger or a pen P, the ultrasonic wave is sensed by the ultrasonic receiving portion 560 at a position corresponding to the touch position. As a result, the touch position where the second panel is touched with a user's finger or a pen P can be sensed.

In addition, lengths of the transmitting areas S and distances D between neighboring transmitting areas S are irregular in the ultrasonic transmitting portion 550. Therefore, ultrasonic waves of various frequencies different from one another are transmitted from a plurality of transmitting areas in the ultrasonic transmitting portion 550.

As a result, the touch position on the second panel 200 can be more accurately sensed by transmitting ultrasonic waves of various frequencies from the ultrasonic transmitting portion 550. In other words, if ultrasonic waves of the same frequency are transmitted from the transmitting areas S of the ultrasonic transmitting portion 550, disturbance or interference on the same frequency may be generated, so that the touch position on the second panel 200 cannot be accurately sensed. However, if ultrasonic waves of different frequencies are transmitted from the ultrasonic transmitting portion 550, the disturbance or interference between the frequencies can be minimized, and thus, the touch position can be more accurately sensed.

An internal construction of the touch panel 10 will now be described in more detail with reference to FIG. 3. FIG. 3 shows a panel assembly 10 where color filters 175 are formed on the first panel 100, i.e., the first insulating substrate 110, in the manner of COA (color filter on array).

The panel assembly 10 includes a first panel 100, a second panel 200 facing the first panel 100, and a liquid crystal layer 300 interposed between the first and second panels 100 and 200 and composed of liquid crystal molecules. In this case, the panels 100 and 200 may have alignment films 301 and 302, respectively. The alignment films 301 and 302 may have a twisted nematic molecule structure in which the liquid crystal molecules of the liquid crystal layer 300 are sequentially twisted from the first panel 100 to the second panel 200, or a homeotropic molecule structure between both panels 100 and 200.

Although not shown in the drawings, the panel assembly 10 may further include a spacer interposed between both panels 100 and 200 for spacing them.

First of all, the first panel 100 will be described in more detail.

A plurality of gate lines 121 are mainly extended in a horizontal direction on the first insulating substrate 110 made of an insulating material such as glass, quartz, ceramic, or plastic. Each gate line 121 has a plurality of portions functioning as a plurality of gate electrodes 124.

In addition, although not shown in the drawings, a sustaining electrode wire line may be formed on the first insulating substrate 110 in the same layer as the gate line 121.

The gate wire line including the gate line 121 and the gate electrode 124 may be made of metal such as Al, Ag, Cr, Ti, Ta, and Mo, or an alloy of them. Although the gate wire lines 121 and 124 according to the embodiment of the present invention are formed in a single layer as shown in FIG. 2, they may have a multi-layered structure including a metal layer formed of metal such as Cr, Mo, Ti, and Ta, or an alloy of them, having excellent physical and chemical properties, and an Al-based or Ag-based metal layer having low resistivity. In addition, the gate wire lines 121 and 124 may be made of various kinds of metal or conductive materials, and more preferably, may have a multi-layered film that can be patterned in the same etching condition. Furthermore, the side surface of the gate wire lines 121 and 124 may be slanted, preferably within an angle range of 30° to 80° with respect to a horizontal surface.

A gate insulating film 130 made of silicon nitride (SiNx) and the like is formed on the gate wire lines 121 and 124.

A plurality of data lines 161, a plurality of source electrodes 165 connected to the data lines 161, and a plurality of drain electrodes 166 are formed on the gate insulating film 130. Each data line 161 is mainly extended in a vertical direction across the gate line 121. A plurality of molecules are emitted from a source electrode 165 to each drain electrode 166. It should be noted that a gate electrode 124, a source electrode 165, and a drain electrode 166 constitute a three-electrode construction of a thin-film transistor.

Similar to the gate wire lines 121 and 124, the data wire lines including the data line 161, the source electrode 165, and the drain electrode 166 may be made of metal such as Cr, Mo, Ti, and Ta, or an alloy of them, and have a single or multi-layered structure.

A semiconductor 140 is formed under the data wire lines 161, 165, and

166. The semiconductor 140 made of amorphous silicon or similar materials functions as a channel of a thin-film transistor among the gate electrode 124, the source electrode 165, and the drain electrode 166.

Ohmic contacts 155 and 156 are formed between the semiconductor 140 and the data wire line 161, 165, and 166 in order to reduce contact resistance therebetween. The ohmic contacts 155 and 156 may be made of silicide or amorphous silicon doped with n-type impurities in a high concentration. An ohmic contact 156, having an island shape, symmetrically faces the other ohmic contact 155 with respect to the gate electrode 124.

The color filters 175 having the three primary colors are sequentially arranged on the data wire lines 161, 165, and 166. In this case, although the color filters 175 according to the embodiment of the present invention have the three primary colors, they may have various colors more than a single color.

In addition, unlike in FIG. 3, the color filters 175 having different colors may overlap on the thin-film transistor, the data line 161, and the gate line 121. In this case, the color filters 175 may also function as a light blocking member 220.

A passivation layer 170 is formed on the color filters 175. The passivation layer 170 may be made of an organic material having excellent flatness and photosensitivity, a low dielectric-constant insulating material formed of a-Si:C:O, a-Si:O:F, or the like through a plasma-enhanced chemical vapor deposition (PECVD), or an inorganic insulating material, such as silicon nitride and the like.

A plurality of contact holes 171 are provided on the passivation layer 170 and the color filters 175 for exposing at least a part of the drain electrode 166.

A plurality of pixel electrodes 180 are formed on the passivation layer 170. The pixel electrodes may be made of a transparent conductive material, such as indium tin oxide (ITO) or indium zinc oxide (IZO).

Now, the second panel 200 will be described in more detail.

A first transparent electrode layer 520, an ultrasonic waveguide layer 510, and a second transparent electrode layer 530 are sequentially stacked on a second insulating substrate 210 made of an insulating material, such as glass, quartz, ceramic, or plastic. Ultrasonic transmitting and receiving portions 550 and 560 are formed on the second transparent electrode layer 530 along the edges of the second insulating substrate 210. In addition, a passivation layer 570 is formed to cover the second transparent electrode layer 530 and the ultrasonic transmitting and receiving portions 550 and 560. The aforementioned components constitute a touch sensing portion 500 to allow the second panel 200 to have an input function.

Subsequently, a light blocking member 220 is formed on the passivation layer 570. The light blocking member 220 has an opening facing the pixel electrode 180 of the first panel 100, and prevents light leakage between the neighboring pixels. Such a light blocking member 220 may be also formed on a position corresponding to the thin-film transistor in order to shield the external light incident to the channel portion of the thin-film transistor.

The light blocking member 220 may have a single-layered construction made of a material selected from a group consisting of chrome, chrome oxide, and chrome nitride, or a multi-layered metal structure made of a combination of them. Also, the light blocking member 220 may include a photosensitive organic material having a black-based pigment in order to provide a light blocking function. The black-based pigment may include carbon black, titanium oxide, or the like.

Unlike the construction shown in FIG. 3, the light blocking member 220 may be omitted depending on the construction of the color filters 175 formed on the first panel 100. In other words, if the color filters 175 formed on the first panel 100 have a light blocking property, then the light blocking member 220 may be omitted from the second panel 200.

A common electrode 280 is formed on the light blocking member 220. The common electrode 280 is used to generate an electric field for driving the liquid crystal molecules in combination with the pixel electrode 180, and may be made of a transparent conductive material. A separate flattening film may be further included between the light blocking member 220 and the common electrode 280.

According to the aforementioned construction of the present invention, it is possible to provide a panel assembly 10 having an input function for receiving signals from outside as well as a display function for displaying images.

In addition, since the touch sensing portion 500 having an input function is integrated into the inside of the panel assembly 10, it is possible to use a continuous batch manufacturing process, and thus, to improve productivity.

In addition, it is possible to maximize an effective display area of the panel assembly 10.

Furthermore, it is possible to minimize degradation of image quality of the panel assembly 10.

Still furthermore, it is possible to prevent defects caused by deterioration of the touch sensing portion 500.

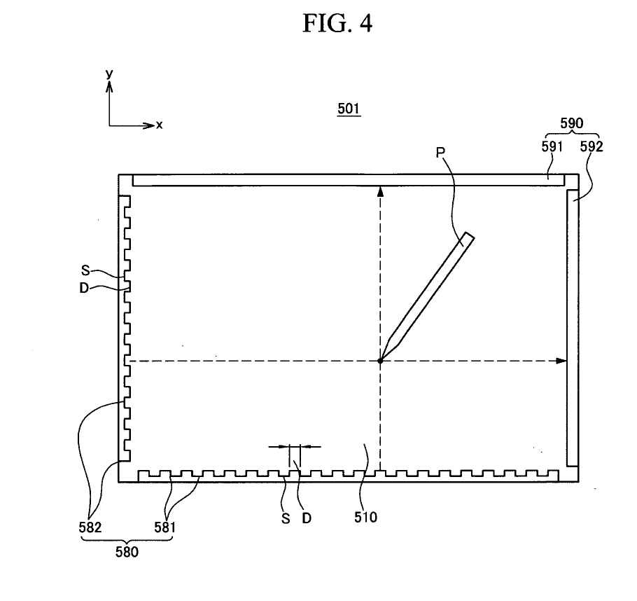

A panel assembly according to a variation of the first embodiment of the present invention will be described with reference to FIG. 4. FIG. 4 is a schematic diagram illustrating a touch sensing portion 501 included in the panel assembly.

As shown in FIG. 4, the touch sensing portion 501 includes an ultrasonic waveguide layer 510 and ultrasonic transmitting and receiving portions 580 and 590.

The ultrasonic transmitting portion 580 includes an X-axis transmitting portion 581 formed at an edge of the ultrasonic waveguide layer 510 and a Y-axis transmitting portion 582 formed at the neighboring edge of the X-axis transmitting portion 582.

The ultrasonic receiving portion 590 includes an X-axis receiving portion 591 formed at the opposite edge to the X-axis transmitting portion 581 and the Y-axis receiving portion 592 formed at the opposite edge to the Y-axis transmitting portion 582.

It should be noted that the ultrasonic transmitting portion 580 has a plurality of transmitting areas S having a predetermined length and separated with a predetermined distance D. The plurality of transmitting areas receive various driving signals, respectively. In other words, although not shown in the drawings, a plurality of driving circuits for supplying driving signals different from one another may be connected to the transmitting areas S of the ultrasonic transmitting portion 580, respectively. Therefore, since different voltages are applied to the plurality of transmitting areas S according to the different driving signals, ultrasonic waves of various frequencies are transmitted from the transmitting areas S.

According to the aforementioned construction, the ultrasonic transmitting portion 580 transmits the ultrasonic waves of various frequencies using a method different from the first embodiment of the present invention. As a result, the touch position on the second panel 200 can be more accurately sensed.

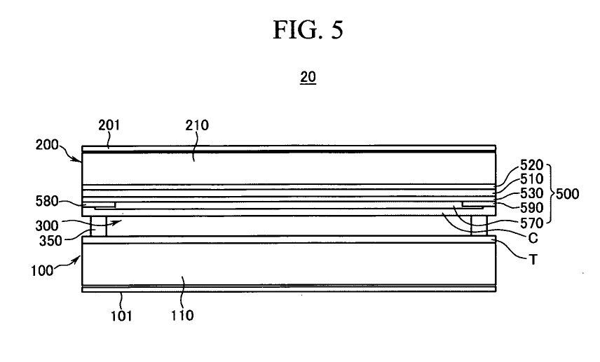

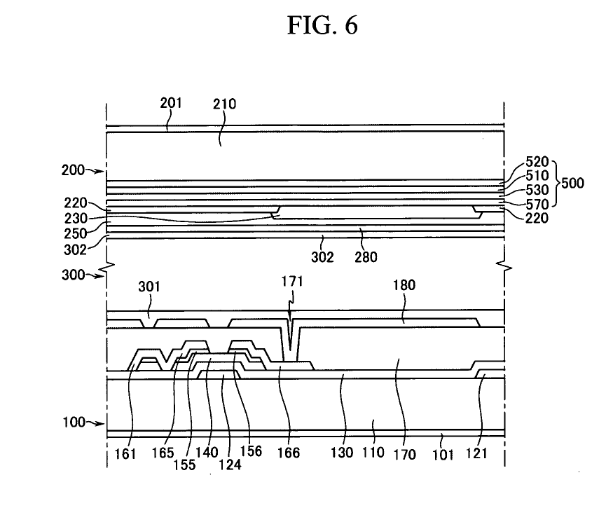

Hereinafter, a second embodiment of the present invention will be described with reference to FIGS. 5 and 6. FIG. 5 is a cross-sectional view illustrating a panel assembly 20 according to the second embodiment of the present invention and FIG. 6 is an enlarged cross-sectional view for describing the panel assembly 20 in more detail.

As shown in FIG. 5, the panel assembly 20 includes a first panel 100, a second panel 200 facing the first panel 100, and a liquid crystal layer 300 interposed between the first and second panels 100 and 200.

The first panel 100 includes a first insulating substrate 110 and a thin-film transistor forming layer T formed on the first insulating substrate 110. The second panel 200 includes a second insulating substrate 210, a touch sensing portion 500 formed on the second insulating substrate 210, a color filter forming layer C, and a common electrode 280 (shown in FIG. 6). It should be noted that the touch sensing portion 500 is formed on the second insulating substrate 210 facing the first panel 100. In addition, the touch sensing portion 500 is interposed between the second insulating substrate 210 and the color filter forming layer C. It should be noted that the color filter forming layer C includes the color filter 230 (shown in FIG. 6), the light blocking member 220 (shown in FIG. 6), and a flattening film 250 (shown in FIG. 6). In addition, both panels 100 and 200 are combined with each other using a sealant, while a liquid crystal layer 300 is interposed between the panels 100 and 200.

As described above, since the second panel 200 includes the touch sensing portion 500, the second panel 200 functions as a touch panel as well as a display panel.

An internal construction of the panel assembly 20 will be described in more detail with reference to FIG. 6.

The first panel 100 includes a first insulating substrate 110, and gate wire lines 121 and 124, a gate insulating film 130, a semiconductor 140, ohmic contacts 155 and 156, data wire lines 161, 165, and 166, a passivation layer 170, and a pixel electrode 180 sequentially formed on the first insulating substrate 110. It should be noted that the first panel 100 does not include the color filter, unlike the first embodiment.

The second panel 200 includes a second insulating substrate 210, and a touch sensing portion 500, a light blocking member 220, a color filter 230, a flattening film 250, and a common electrode 280 sequentially formed on the second insulating substrate 210.

The touch sensing portion 500 includes a first transparent electrode layer 520, an ultrasonic waveguide layer 510, a second transparent electrode layer 530, an ultrasonic transmitting portion 550, an ultrasonic receiving portion 560, and a passivation layer 570. The light blocking member 220 and the color filter 230 are formed on the passivation layer 570 of the touch sensing portion 500.

According to the aforementioned construction, it is possible to provide a panel assembly 20 having an input function for receiving signals from outside as well as a display function for displaying images.

In addition, since the touch sensing portion 500 having an input function is integrated into the inside of the panel assembly 20, it is possible to use a continuous batch manufacturing process, and thus, to improve productivity.

In addition, it is possible to maximize an effective display area of the panel assembly 20.

Furthermore, it is possible to minimize degradation of image quality in the panel assembly 20.

Still furthermore, it is possible to prevent defects caused by degradation of the touch sensing portion 500.

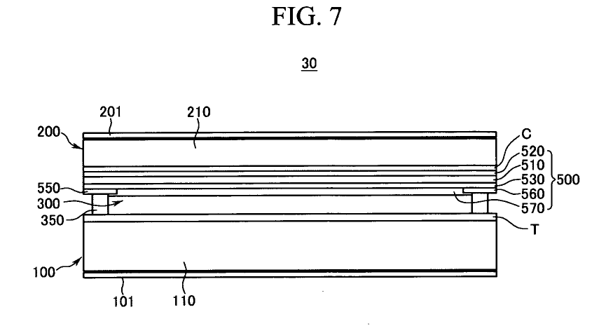

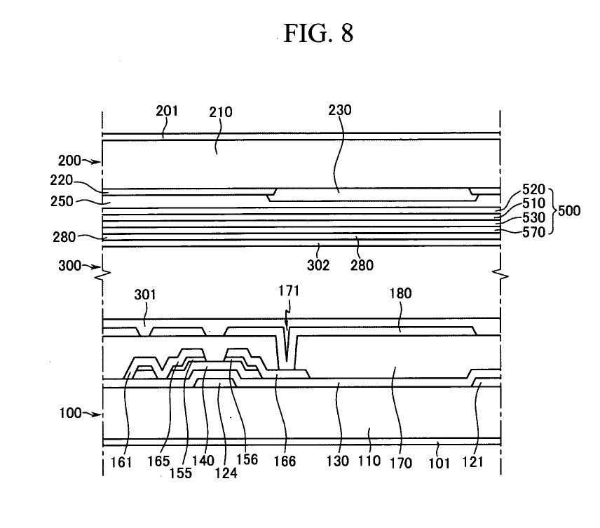

Hereinafter, a third embodiment of the present invention will be described with reference to FIGS. 7 and 8. FIG. 7 is a cross-sectional view illustrating a panel assembly 30, and FIG. 8 is an enlarged cross-sectional view illustrating the panel assembly 30 in more detail.

Referring to FIG. 7, the panel assembly 30 includes a first panel 100, a second panel 200 facing the first panel 100, and a liquid crystal layer 300 interposed between the first and second panels 100 and 200 and is composed of liquid crystal molecules.

The first panel 100 includes a first insulating substrate 110 and a thin-film transistor forming layer T formed on the first insulating substrate 110. The second panel 200 includes a second insulating substrate 210, and a touch sensing portion 500, a color filter forming layer C, and a common electrode 280 (shown in FIG. 8) formed on the second insulating panel 210. It should be noted that the touch sensing portion 500 is formed on the second insulating substrate 210 facing the first panel 100. In addition, the color filter forming layer C is interposed between the second insulating substrate 210 and the touch sensing portion 500. It should be noted that the color filter forming layer C includes a color filter 230 (shown in FIG. 8), a light blocking member 220 (shown in FIG. 8), and a flattening film 250 (shown in FIG. 8). In addition, both panels 100 and 200 are attached to face each other using a sealant, and a liquid crystal layer 300 is interposed between the panels 100 and 200.

As described above, since the second panel 200 includes the touch sensing portion 500, it is possible to provide a second panel 200 having functions of a touch panel as well as a display panel.

An internal construction of the panel assembly 30 will be described in more detail with reference to FIG. 8.

The first panel 100 includes a first insulating substrate 110, and gate wire lines 121 and 124, a gate insulating film 130, a semiconductor 140, ohmic contacts 155 and 156, data wire lines 161, 165, and 166, a passivation layer 170, and a pixel electrode 180 sequentially formed on the first insulating substrate 110.

The second panel 200 includes a second insulating substrate 210, and a light blocking member 220, a color filter 230, a flattening film 250, a touch sensing portion 500, and a common electrode 280 sequentially formed on the second insulating panel 210.

The touch sensing portion 500 includes a first transparent electrode layer 520, an ultrasonic waveguide layer 510, a second transparent electrode layer 530, an ultrasonic transmitting portion 550, an ultrasonic receiving portion 560, and a passivation layer 570. The first transparent electrode layer 510 of the touch sensing portion 500 is formed on the flattening film 250, and the common electrode 280 is formed on the passivation layer 570 of the touch sensing portion 500.

According to the aforementioned construction, it is possible to provide a panel assembly 30 having an input function for receiving signals from outside as well as a display function for displaying images.

In addition, since the touch sensing portion 500 having an input function is integrated into the inside of the panel assembly 30, it is possible to use a continuous manufacturing process, and thus, to improve productivity.

In addition, it is possible to maximize an effective display area of the panel assembly 30.

Furthermore, it is possible to minimize degradation of image quality in the panel assembly 30.

Still furthermore, it is possible to prevent defects caused by deterioration of the touch sensing portion 500.

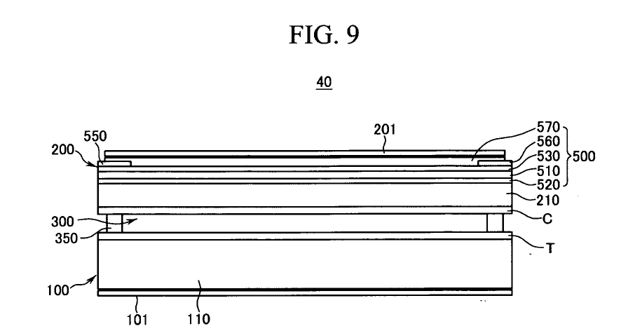

Hereinafter, a fourth embodiment of the present invention will be described with reference to FIG. 9.

As shown in FIG. 9, the panel assembly 40 includes a first panel 100, a second panel 200 facing the first panel 100, and a liquid crystal layer 300. The liquid crystal layer 300 is interposed between the first and second panels 100 and 200 and is composed of liquid crystal molecules.

The first panel 100 includes a first insulating substrate 110 and a thin-film transistor forming layer T formed on the first insulating substrate 110. The second panel 200 includes a second insulating substrate 210, and a touch sensing portion 500 and a color filter forming layer C sequentially formed on the second insulating panel 210. It should be noted that the color filter forming layer C is formed on the second insulating substrate 210 facing the first panel 100, and the touch sensing portion 500 is formed beneath the second insulating substrate 210 facing the first panel 100.

The touch sensing portion 500 includes a first transparent electrode layer 520, an ultrasonic waveguide layer 510, a second transparent electrode layer 530, an ultrasonic transmitting portion 550, an ultrasonic receiving portion 560, and a passivation layer 570. In addition, a second polarization plate 201 is attached to the passivation layer 570 of the touch sensing portion 500.

As described above, since the second panel 200 includes the touch sensing portion 500, it is possible to provide a second panel having functions of a touch panel as well as a display panel. In other words, the panel assembly 40 can have an input function for receiving signals from outside as well as a display function for displaying images.

In addition, since the touch sensing portion 500 having an input function is integrated into the inside of the second panel 200 of the panel assembly, it is possible to use a continuous batch manufacturing process, and thus, to improve productivity.

As described above, according to the present invention, it is possible to provide a panel assembly having an input function for receiving signals from outside as well as a display function for displaying images.

In other words, the panel assembly according to the present invention has a touch sensing function capable of directly sensing an external touch.

In addition, since the touch sensing portion having an input function is integrated into the inside of the panel assembly, it is possible to use a continuous batch manufacturing process, and thus, to improve productivity.

In addition, it is possible to maximize an effective display area of the panel assembly.

Furthermore, it is possible to minimize degradation of image quality in the panel assembly.

Still furthermore, it is possible to prevent defects caused by deterioration of the touch sensing portion.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A panel assembly comprising:
a first panel having a first insulating substrate;
a second panel having a second insulating substrate, the second panel facing the first panel;
and a touch sensing portion formed on the second insulating substrate.

2. The panel assembly of claim 1, wherein the touch sensing portion comprises:
an ultrasonic waveguide layer formed on the second insulating substrate;
ultrasonic transmitting and receiving portions formed on the ultrasonic waveguide layer; and
a passivation layer formed on the ultrasonic waveguide layer.

3. The panel assembly of claim 2, wherein the touch sensing portion is formed on the second insulating substrate facing the first panel.

4. The panel assembly of claim 3,
wherein the first panel comprises a thin-film transistor, a pixel electrode, and a color filter formed on the first insulating substrate, and
wherein the second panel further comprises a common electrode formed on the second insulating substrate.

5. The panel assembly of claim 4, wherein the touch sensing portion further comprises a transparent electrode layer interposed between the second insulating substrate and the ultrasonic waveguide layer.

6. The panel assembly of claim 4, wherein the touch sensing portion further comprises a transparent electrode layer surrounded by the ultrasonic waveguide layer, the ultrasonic transmitting and receiving portions, and the passivation layer.

7. The panel assembly of claim 4, wherein the touch sensing portion further comprises:
a first transparent electrode layer interposed between the second insulating substrate and the ultrasonic waveguide layer; and
a second transparent layer surrounded by the ultrasonic waveguide layer, the ultrasonic transmitting and receiving portions, and the passivation layer.

8. The panel assembly of claim 3,
wherein the first panel comprises a thin-film transistor formed on the first insulating substrate and a pixel electrode, and
wherein the second panel further comprises a color filter formed on the second insulating substrate and a common electrode.

9. The panel assembly of claim 8, wherein the color filter is interposed between the second insulating substrate and the touch sensing portion.

10. The panel assembly of claim 9, wherein the touch sensing portion further comprises a transparent electrode layer interposed between the second insulating substrate and the ultrasonic waveguide layer.

11. The panel assembly of claim 9, wherein the touch sensing portion further comprises a transparent electrode layer surrounded by the ultrasonic waveguide layer, the ultrasonic transmitting and receiving portions, and the passivation layer.

12. The panel assembly of claim 9, wherein the touch sensing portion further comprises:
a first transparent electrode layer interposed between the second insulating substrate and the ultrasonic waveguide layer; and
a second transparent electrode layer surrounded by the ultrasonic waveguide layer, the ultrasonic transmitting and receiving portions, and the passivation layer.

13. The panel assembly of claim 8, wherein the touch sensing portion is interposed between the second insulating substrate and the color filter.

14. The panel assembly of claim 13, wherein the touch sensing portion further comprises a transparent electrode layer interposed between the second insulating substrate and the ultrasonic waveguide layer.

15. The panel assembly of claim 13, wherein the touch sensing portion further comprises a transparent layer surrounded by the ultrasonic waveguide layer, the ultrasonic transmitting and receiving portions, and the passivation layer.

16. The panel assembly of claim 13, wherein the touch sensing portion further comprises:
a first transparent electrode layer interposed between the second insulating substrate and the ultrasonic waveguide layer; and
a second transparent electrode layer surrounded by the ultrasonic waveguide layer, the ultrasonic transmitting and receiving portions, and the passivation layer.

17. The panel assembly of claim 2,
wherein the ultrasonic transmitting portion comprises an X-axis transmitting portion formed at an edge of the ultrasonic waveguide layer and a Y-axis transmitting portion formed at a neighboring edge to the X-axis transmitting portion, and
wherein the ultrasonic receiving portion comprises an X-axis receiving portion formed at an opposite edge to the X-axis transmitting portion and a Y-axis receiving portion formed at an opposite edge to the a Y-axis transmitting portion.

18. The panel assembly of claim 17,
wherein the ultrasonic transmitting portion comprises a plurality of transmitting areas, and lengths of the plurality of transmitting areas and distances between the neighboring transmitting areas are irregular, and
wherein the ultrasonic transmitting portion transmits ultrasonic waves of various frequencies from the plurality of transmitting areas.

19. The panel assembly of claim 18, wherein the touch sensing portion is formed beneath the second insulating substrate facing the first panel.

20. The panel assembly of claim 17,
wherein the ultrasonic transmitting portion comprises a plurality of transmitting areas, and
wherein the ultrasonic transmitting portion receives various driving signals and transmitting ultrasonic waves of various frequencies from the plurality of transmitting areas.

21. The panel assembly of claim 20, wherein the touch sensing portion is formed beneath the second insulating substrate facing the first panel.
